(19) United States
(12) Patent Application Publication
(10) Pub. No.: US 2026/0187386 A1
(43) Pub. Date: Jul. 2, 2026

(54) METHOD FOR GENERATING TRAINING DATA FOR MACHINE TRANSLATION, METHOD FOR CREATING LEARNABLE MODEL FOR MACHINE TRANSLATION PROCESSING, MACHINE TRANSLATION PROCESSING METHOD, AND DEVICE FOR GENERATING TRAINING DATA FOR MACHINE TRANSLATION

(71) Applicant: National Institute of Information and Communications Technology, Koganei-shi, Tokyo (JP)

(72) Inventor: Masao UCHIYAMA, Koganei-shi (JP)

(21) Appl. No.: 18/873,589

(22) PCT Filed: May 9, 2023
(86) PCT No.: PCT/JP2023/017453

§ 371 Date: Aug. 27, 2025

(30) Foreign Application Priority Data
Jun. 16, 2022 (JP) 2022-097221

(51) Int. Cl. G06F 40/58; G06F 40/117

(52) U.S. Cl. CPC G06F 40/58; G06F 40/117

(57) ABSTRACT

Provided is a machine translation processing system that enables highly accurate machine translation of source sentences including markup language tags while retaining information about the markup language tags, without the need to prepare a large amount of parallel translation data including tags. As described above, in the machine translation processing system 1000, the training data generation device 1 performs training data generation processing to detect the start/end correspondence codes and replace the detected start/end correspondence codes with alternative codes in parallel translation sentences that do not include markup language tags, thereby allowing for easily generating a large amount of data equivalent to parallel translation data into which markup language tags have been inserted. Using the parallel translation data obtained through the training data generation processing by the training data generation device 1 in the machine translation processing system 1000 as training data for learning processing of the machine translation model achieves the same advantageous effect as when the machine translation model learning processing is performed using the parallel translation sentences with markup language tags as training data.

### TECHNICAL FIELD

The present invention relates to machine translation processing technology, and particularly to machine translation processing technology that supports tags in markup languages.

### BACKGROUND ART

In the field of industrial translation, original texts (source language data (source language sentences)) to be translated often contain XML tags (an example of markup language tags), and there is a high demand for machine translation of the original texts containing such tags with high accuracy while retaining the tag information.

As a method for dealing with cases where the original texts to be translated contain XML tags, for example, as disclosed in non-patent document 1, there is a method in which the tags of the original texts are removed during machine translation, and then the tags are reinserted into the machine translation result based on word alignment between the source texts and the translated texts.

Additionally, Patent Document 1 discloses a technique for training a machine translation engine using parallel translation data into which markup language tags (for example, XML tags) have been inserted. In the technique of Patent Document 1, in a case in which a machine translation engine is to be trained, markup language tags are replaced with placeholders, and then the machine translation engine is trained using parallel translation data (paired data with source and target texts) in which markup language tags have been replaced with placeholders. In the technique of Patent Document 1, when machine translation is performed, the tags in the original text are replaced with placeholders and then the original text in which the tags have been replaced with the placeholders is machine-translated; after that, the placeholders in the machine-translated text are replaced with the original tags.

### PRIOR ART DOCUMENTS

### Patent Documents

Patent Document 1: U.S. Pat. No. 10,963,652

### Non-Patent Documents

Non-Patent Document 1: Mathias Mueller. Treatment of Markup in Statistical Machine Translation. Proceedings of the Third Workshop on Discourse in Machine Translation, pages 36-46, Copenhagen, Denmark, Sep. 8, 2017. Association for Computational Linguistics.

### DISCLOSURE OF INVENTION

### Technical Problem

However, the method of re-inserting tags disclosed in Non-Patent Document 1 has the advantage that the machine translation engine can be trained even if the tags are not included in the parallel translation data; however, translation is performed with the tags not considered during machine translation, and thus it is difficult to provide translation with tags properly retained.

Conversely, the method of training a machine translation engine using parallel translation data including tags disclosed in Patent Document 1 has no problem with translation accuracy or tag retention accuracy, but has the problem that it is difficult to prepare a large amount of parallel translation data including tags.

In view of the above-mentioned problems, it is an object of the present invention to provide a machine translation processing method, a method for generating training data for machine translation, a method for creating learnable model for machine translation processing, a machine translation processing method, a device for generating training data for machine translation, and a machine translation processing system that enables highly accurate machine translation of source texts (source language data (source language sentences)) including markup language tags while retaining information about the markup language tags, without the need to prepare a large amount of parallel translation data including tags.

### Solution to Problem

To solve the above problems, a first aspect of the present invention provides a method for generating training data for machine translation, which is for generating training data for training a learnable model for machine translation processing in a machine translation processing system for machine translation processing of language data including markup language tags; the method includes a start/end correspondence code detection step and a replacement processing step.

The start/end correspondence code detection step detects a start/end correspondence code, whose correspondence between a start indication code and an end indication code has been established, in parallel translation data in which first language data is paired with second language data obtained by translating the first language data into second language data, the parallel translation data not including the markup language tags.

The replacement processing step performs replacement processing in which the start/end correspondence code is replaced with an alternative code for the parallel translation data to obtain parallel translation data after the replacement processing.

The machine translation processing method performs training data generation processing to detect the start/end correspondence codes (codes whose left and right sides correspond, such as ( ) and [ ]) and replace the detected start/end correspondence codes with alternative codes (placeholders) in parallel translation sentences (parallel translation data) that do not include markup language tags (e.g., XML tags), thereby allowing for easily generating a large amount of data equivalent to parallel translation data into which markup language tags (e.g., XML tags) have been inserted.

The parallel translation data obtained in the training data generation processing by the method for generating training data for machine translation includes alternative codes (placeholders) corresponding to the markup language tags; thus, using the parallel translation data as training data for learning processing of the machine translation model achieves the same advantageous effect as when the machine translation model learning processing is performed using the parallel translation sentences (parallel translation data) with markup language tags (e.g., XML tags) as training data (equivalent learning processing can be performed).

A second aspect of the present invention provides the method for generating training data for machine translation of the first aspect of the present invention further including a replacement ratio setting step of setting a replacement ratio.

The replacement processing step includes performing replacement processing on the parallel translation data to replace the start/end correspondence code with an alternative code at the replacement ratio set in the replacement ratio setting step.

In the method for generating training data for machine translation, setting the replacement ratio by the replacement ratio setting step (by setting it to a value less than 1.0) guarantees that all start/end correspondence codes will not be replaced with alternative codes (placeholders). As a result, in the method for generating training data for machine translation, it is guaranteed that the parallel translation data after the replacement processing includes the start/end correspondence codes, thereby making it possible to appropriately learn (train) for the start/end correspondence codes (making it possible to make the start/end correspondence codes in the source language data correctly appear (correctly machine translated) in the machine translation processing result data (translation target language data)).

Note that the replacement ratio may be set in units of parallel translation data (in units of parallel translation sentences). In other words, when there are N1 (N1 is a natural number) pieces of parallel translation data including start/end correspondence codes among the parallel translation data to be processed, and the replacement ratio is r (r is a real number satisfying 0<r<1), replacement processing may be performed on int(N1×r) pieces of parallel translation data (int(x): a function that obtains the largest integer value not exceeding x) among the parallel translation data including the start/end correspondence codes.

A third aspect of the present invention provides a method for creating a learnable model for machine translation processing in a machine translation processing system for performing machine translation processing on language data including markup language tags using training data generated by the method for generating training data for machine translation according to the first or second aspect of the present invention; the method includes a data input step, an output data obtaining step, a loss evaluation step, and a parameter updating step.

The data input step inputs the first language data included in the parallel translation data after the replacement processing into the learnable model for the machine translation processing.

The output data obtaining step obtains output data of the learnable model for machine translation processing for the data inputted in the data input step.

The loss evaluation step obtains the output data obtained in the output data obtaining step and the second language data included in the parallel translation data after the replacement processing as correct data, and evaluates a loss between the output data and the correct data.

The parameter updating step updates parameters of the learnable model for machine translation processing so that the loss obtained in the loss evaluation step is reduced.

In the method for creating the learnable model for machine translation processing, it is possible to train the learnable model for machine translation processing using first language data included in parallel translation data after replacement processing and second language data included in parallel translation data after replacement processing as correct data, thus making it possible to obtain a trained model of the learnable model that machine-translates first language data after replacement processing into second language data after replacement processing.

A fourth aspect of the present invention provides a machine translation processing method for performing machine translation processing using a learned model obtained by training a learnable model for machine translation processing by the method for creating a learnable model for machine translation processing according to the third aspect of the present invention; the method includes a forward replacement processing step, a machine translation processing step, and an inverse replacement processing step.

The forward replacement processing performs forward replacement processing of replacing the markup language tag included in the input first language data with the alternative code.

The machine translation processing step performs machine translation processing on first language data after the forward replacement processing using the learned model of the learnable model for machine translation processing to obtain second language data after machine translation processing.

The inverse replacement processing step performs inverse replacement processing of replacing the alternative code included in the second language data after the machine translation processing obtained in the machine translation processing step with the markup language tag that has been replaced in the forward replacement processing step.

The machine translation processing method for performing machine translation processing performs machine translation processing with the trained model of the machine translation model that has been optimized with the parallel translation data, in which, for input data including markup language tags (e.g., XML tags), the markup language tags have been replaced with alternative codes (placeholders) similar to those used when generating training data and the alternative codes have been inserted, thus allowing for obtaining appropriate machine translation processing result data while appropriately maintaining a state in which the alternative codes have been inserted. The machine translation processing method for performing machine translation processing replaces the alternative codes with the XML tags in the machine translation processing result data (machine-translated sentences) in which the alternative codes have been inserted, thereby allowing for obtaining machine translation processing result data in which the XML tags have been appropriately inserted.

In this way, with this machine translation processing method, the original text (source language data (source language sentences)) to be translated that includes markup language tags can be translated with high precision while retaining the information of the markup language tags without preparing a large amount of parallel translation sentences including tags.

A fifth aspect of the present invention provides a method for generating training data for machine translation, which is for generating training data for training a learnable model for machine translation processing in a machine translation processing system for machine translation processing of language data including markup language tags; the method includes a corresponding element detection step, and a replacement processing step.

The corresponding element detection step detects a corresponding element that is determined to be an element whose correspondence between first language data and second language has been established for the parallel translation data that is obtained by pairing the first language data with the second language data, which is obtained by translating the first language data into second language data; the parallel translation data does not include the markup language tags.

The replacement processing step performs replacement processing on the parallel translation data to insert alternative codes before and after the corresponding element, thereby obtaining parallel translation data after the replacement processing.

The method for generating training data for machine translation detects element(s) for which correspondence between original sentences and its translated sentences has been established in parallel translation sentences (parallel translation data) that do not include markup language tags (e.g., XML tags), and then inserts alternative codes (placeholders) before and after the detected element(s), thereby allowing for easily generating a large amount of data equivalent to parallel translation data into which markup language tags (e.g., XML tags) have been inserted.

A sixth aspect of the present invention provides a device for generating training data for machine translation, which is for generating training data for training a learnable model for machine translation processing in a machine translation processing system for performing machine translation processing on language data including markup language tags; the device includes a replacement processing unit.

The replacement processing detects a start/end correspondence code, whose correspondence between a start indication code and an end indication code has been established, in parallel translation data in which first language data is paired with second language data obtained by translating the first language data into second language data; the parallel translation data does not include the markup language tags. Furthermore, the replacement processing unit performs replacement processing in which the start/end correspondence code is replaced with an alternative code for the parallel translation data to obtain parallel translation data after the replacement processing.

This achieves a training data generation device for machine translation that has the same effects as the first aspect of the present invention.

### Advantageous Effects

The present invention provides a machine translation processing method, a method for generating training data for machine translation, a method for creating learnable model for machine translation processing, a machine translation processing method, a device for generating training data for machine translation, and a machine translation processing system that enables highly accurate machine translation of source texts (source language data (source language sentences)) including markup language tags while retaining information about the markup language tags, without the need to prepare a large amount of parallel translation data including tags.

### BRIEF DESCRIPTION OF THE DRAWINGS

FIG. 1 is a schematic configuration diagram of a machine translation processing system 1000 according to a first embodiment.

FIG. 2 is a flowchart of training data generation processing performed by the machine translation processing system 1000.

FIG. 3 is a diagram for explaining replacement processing performed by a training data generation device 1 of the machine translation processing system 1000.

FIG. 4 is a flowchart of prediction processing (machine translation execution processing) performed by the machine translation processing system 1000.

FIG. 5 is a diagram for explaining prediction processing (machine translation execution processing) of the machine translation processing system 1000.

FIG. 6 is a diagram showing results of machine translation processing of first language data (Japanese data) with XML tags by the machine translation processing system 1000.

FIG. 7 is a schematic configuration diagram of a machine translation processing system 2000 according to a second embodiment.

FIG. 8 is a diagram for explaining replacement processing performed by a training data generation device 1A of the machine translation processing system 2000.

FIG. 9 is a diagram showing a CPU bus configuration.

### DESCRIPTION OF THE PREFERRED EMBODIMENTS

### First Embodiment

A first embodiment will be described below with reference to the drawings.

### 1.1: Configuration of Machine Translation Processing System

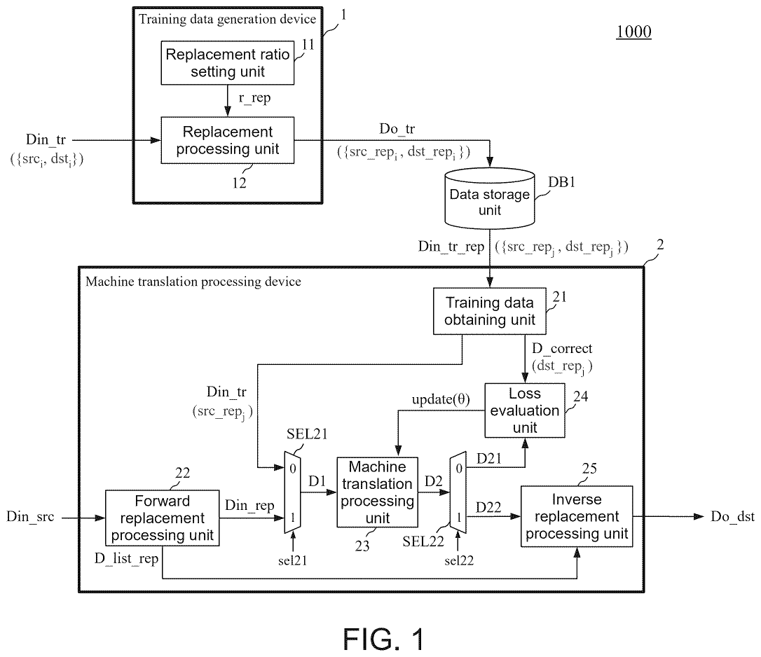

FIG. 1 is a schematic configuration diagram of a machine translation processing system 1000 according to a first embodiment.

As shown in FIG. 1, the machine translation processing system 1000 includes a training data generation device 1, a data storage unit DB1, and a machine translation processing device 2. Note that the following explanation assumes that the target of machine translation processing is language data that includes markup language tags, but the target of machine translation processing device 2 does not necessarily need to include markup language tags; if input data that does not include tags is provided, machine translation processing is performed without performing any replacement processing or the like.

As shown in FIG. 1, the training data generation device 1 includes a replacement ratio setting unit 11 and a replacement processing unit 12.

The replacement ratio setting unit 11 sets a ratio of replacing start/end correspondence codes with alternative codes (placeholders). The replacement ratio setting unit 11 then transmits data (referred to as “replacement ratio data”) indicating the ratio of replacing the set start/end correspondence codes with the alternative codes (placeholders) to the replacement processing unit 12 as data r_rep.

The replacement processing unit 12 receives parallel translation data Din_tr in which first language data (source language data) is paired with second language data (translation target language data) and furthermore markup language tags are not included. The replacement processing unit 12 also receives replacement ratio data r_rep transmitted from the replacement ratio setting unit 11. The replacement processing unit 12 performs processing of replacing the start/end correspondence codes included in the parallel translation data Din_tr with alternative codes (placeholders) at the ratio indicated by the replacement ratio data r_rep. The replacement processing unit 12 then transmits the parallel translation data after replacement processing to the data storage unit DB1 as parallel translation data Do_tr after replacement processing.

For convenience of explanation, the parallel translation data Din_tr inputted into the training data generation device 1 are N sets (N is a natural number), and i-th (i is a natural number satisfying 1≤i≤N) first language data (source language data) of the parallel translation data Din_tr is denoted as “srcᵢ”; second language data (translation target language data), which is translated data of the first language into the second language, is denoted as “dstᵢ”; and i-th parallel translation data is denoted as “{srcᵢ, dstᵢ}”.

In addition, i-th first language data (first language data of replacement processing word) of the parallel translation data Do_tr after replacement processing is denoted as “src_repᵢ”; second language data (second language data after replacement processing) that is paired with the first language data for constituting parallel translation data is denoted as “dst_repᵢ”; and i-th data (parallel translation data) of the parallel translation data Do_tr after replacement processing is denoted as “{src_repᵢ, dst_repᵢ}”.

The data storage unit DB1 receives the parallel translation data Do_tr after replacement processing transmitted from the training data generation device 1, and stores and holds the data. In addition, the data storage unit DB1 reads out stored data (parallel translation data Do_tr after replacement processing) in accordance with a command from the machine translation processing device 2, and then transmits the read-out data to the machine translation processing device 2 as data Din_tr_rep. As shown in FIG. 1, the machine translation processing device 2 includes a training data obtaining unit 21, a forward replacement processing unit 22, a first selector SEL21, a machine translation processing unit 23, a second selector SEL22, a loss evaluation unit 24, and an inverse replacement processing unit 25.

The training data obtaining unit 21 outputs a data read command to the data storage unit DB1 to read out parallel translation data, which has been stored in the data storage unit DB1, from the data storage unit DB1 as parallel translation data Din_tr_rep for training. The training data obtaining unit 21 obtains first language data (translation source language data) from the parallel translation data Din_tr_rep for training, and transmits the obtained first language data (translation source language data) as input data Din_tr for training to the first selector SEL21. The training data obtaining unit 21 also obtains, from the parallel translation data Din_tr_rep for training, second language data (translation target language data) that is paired with the first language data transmitted to the first selector SEL21 for constituting parallel translation data, and then transmits the obtained second language data (translation target language data) to the loss evaluation unit 24 as correct data D_correct for training.

For convenience of explanation, it is assumed that the training data obtaining unit 21 reads out M sets (M is a natural number satisfying MEN) of parallel translation data Din_tr after replacement processing from the data storage unit DB1; j-th (j is a natural number satisfying 1≤j≤M) first language data of the read-out parallel translation data Din_tr is denoted as “src_repⱼ”; second language data that is paired with the first language data (constituting parallel translation data) is denoted as “dst_repⱼ”; and j-th data (parallel translation data) of the parallel translation data Din_tr is denoted as “{src_repⱼ, dst_repⱼ}”.

The forward replacement processing unit 22 receives, as data Din_src, first language data (translation source language data) that is to be subjected to machine translation processing and includes markup language tags (e.g., XML tags). The forward replacement processing unit 22 performs processing (forward replacement processing) to replace the markup language tags included in the data Din_src with alternative codes (placeholders). The forward replacement processing unit 22 then transmits the first language data after the forward replacement processing to the first selector SEL21 as data Din_rep. In addition, the forward replacement processing unit 22 generates a list of correspondences between markup language tags and alternative codes (placeholders), which have replaced the markup language tags in the forward replacement processing, and then transmits the data including the list to the inverse replacement processing unit 25 as data D_list_rep.

The first selector SEL21 receives the data Din_tr transmitted from the training data obtaining unit 21 and the data Din_rep transmitted from the forward replacement processing unit 22. The first selector SEL21 also receives a selection signal sel21 transmitted from a control unit (not shown) that controls each functional unit in the machine translation processing device 2. The first selector SEL21 selects either data Din_tr or data Din_rep in accordance with the selection signal se21, and then transmits the selected data to the machine translation processing unit 23 as data D1.
(1) When the machine translation processing unit 23 performs learning processing (training processing) (during learning processing (during training)), the control unit transmits the selection signal sel21 whose signal value is “0” to the first selector SEL21, and the first selector SEL21 selects the data Din_tr in accordance with the selection signal and then transmits the selected data Din_tr to the machine translation processing unit 23 as data D1.
(2) When the machine translation processing unit 23 performs prediction processing (machine translation processing) (during prediction processing (during execution of machine translation)), the control unit transmits the selection signal sel21 whose signal value is “1” to the first selector SEL21, and the first selector SEL21 selects the data Din_rep in accordance with the selection signal and then transmits the selected data Din_rep to the machine translation processing unit 23 as data D1.

The machine translation processing unit 23 includes a machine translation model, and receives the data D1 transmitted from the first selector SEL21. The machine translation model included in the machine translation processing unit 23 is a learnable model (a model in which a trained model is provided by optimizing parameters through training based on data), and is a model that is used for learning machine translation (e.g., a machine translation model using a neural network).
(1) During learning processing (training), the machine translation model of the machine translation processing unit 23 receives data D1 (=Din_tr) from the first selector SEL21, and transmits the data obtained by the machine translation model to the second selector SEL22 as data D2. Also, during learning processing (training), the machine translation model of the machine translation processing unit 23 receives parameter update data update(θ) transmitted from the loss evaluation unit 24, and parameters of the machine translation model of the machine translation processing unit 23 are updated based on the parameter update data update(θ) (For example, if the machine translation model of the machine translation processing unit 23 is a model using a neural network, the parameters are updated using the backpropagation method).
(2) During prediction processing (when machine translation processing is performed), the machine translation model of the machine translation processing unit 23 (the machine translation model in which the optimal parameters obtained by the learning processing have been set (trained model)) receives the data D1 (=Din_rep) from the first selector SEL21, and transmits data obtained by the machine translation model (trained model) of the machine translation processing unit 23 to the second selector SEL22 as data D2.

The second selector SEL22 receives the data D2 transmitted from the machine translation processing unit 23 and a selection signal sel22 transmitted from the control unit (not shown) that controls each functional unit in the machine translation processing device 2. The second selector SEL22 transmits the data D2 to either the loss evaluation unit 24 or the inverse replacement processing unit 25 in accordance with the selection signal sel22.
(1) When the machine translation processing unit 23 performs learning processing (training processing) (during learning processing (during training)), the control unit transmits the selection signal sel22 whose signal value is “O” to the second selector SEL22, and then the second selector SEL22 transmits the data D2 to the loss evaluation unit 24 as data D21 in accordance with the selection signal.
(2) When the machine translation processing unit 23 performs prediction processing (during prediction processing (machine translation processing)), the control unit sets the selection signal sel22 whose signal value is “1” to the second selector SEL22, and then the second selector SEL22 transmits the data D2 as data D22 to the inverse replacement processing unit 25 in accordance with the selection signal.

The loss evaluation unit 24 receives the training correct data D_correct transmitted from the training data obtaining unit 21 and the data D21 transmitted from the second selector SEL22. The loss evaluation unit 24 evaluates a loss (e.g., error) between the data D21 and the training correct data D_correct using, for example, a loss function, and based on the evaluation result, generates parameter update data update(θ) that is data for updating parameters of the machine translation model of the machine translation processing unit 23. The loss evaluation unit 24 then transmits the generated parameter update data update(θ) to the machine translation processing unit 23. Note that in FIG. 1, the path from the output of the machine translation processing unit 23 to the loss evaluation unit 24 and the path for outputting parameter update data update(θ) from the loss evaluation unit 24 to the machine translation processing unit 23 are illustrated as separate paths, but this is for convenience (for convenience of illustration) and should not be limited to the form shown in FIG. 1. When the parameters of the machine translation model of the machine translation processing unit 23 is updated in the machine translation processing device 2 using the backpropagation method, an error obtained by the loss evaluation unit 24 (error obtained by an error function (e.g., cross-entropy error)) is propagated sequentially (back-propagated) along a path that reverses the path (forward propagation path) along which output data was obtained by the machine translation model in the machine translation processing unit 23, thereby updating each parameter of the machine translation model of the machine translation processing unit 23 (thereby updating parameters of each layer of the machine translation model of the machine translation processing unit 23).

In addition, the loss evaluation unit 24 determines that there is no need to continue the learning processing when (1) the obtained error (loss) falls within a predetermined range, or (2) the amount of change in the error (loss) falls within a predetermined range, and then terminates the learning processing.

The inverse replacement processing unit 25 receives the data D22 transmitted from the second selector SEL22 and the data D_list_rep transmitted from the forward replacement processing unit 22. The inverse replacement processing unit 25 detects the alternative codes (placeholders) replaced by the forward replacement processing unit 22 from the data D22, and performs processing (inverse replacement processing) for returning (replacing) the detected alternative codes to (with) the original markup language tags based on the list contained in the data D_list_rep (a list of correspondences between markup language tags and the alternative codes (placeholders) that have replaced the markup language tags in the forward replacement processing). The inverse replacement processing unit 25 transmits the data after performing the inverse replacement processing on the data D22 as output data Do_dst.

### 1.2: Operation of Machine Translation Processing System

The operation of the machine translation processing system 1000 configured as above will be described.

In the following, the operation of the machine translation processing system 1000 will be described in three parts: (1) training data generation processing, (2) machine translation model learning processing (training process) (creation method), and (3) prediction processing (machine translation execution processing).

For convenience of explanation, it is assumed that the machine translation processing system 1000 is a system for performing processing of machine translating a first language (translation source language) into a second language (translation target language).

### 1.2.1: Training Data Generation Processing

First, the training data generation processing performed by the machine translation processing system 1000 will be described.

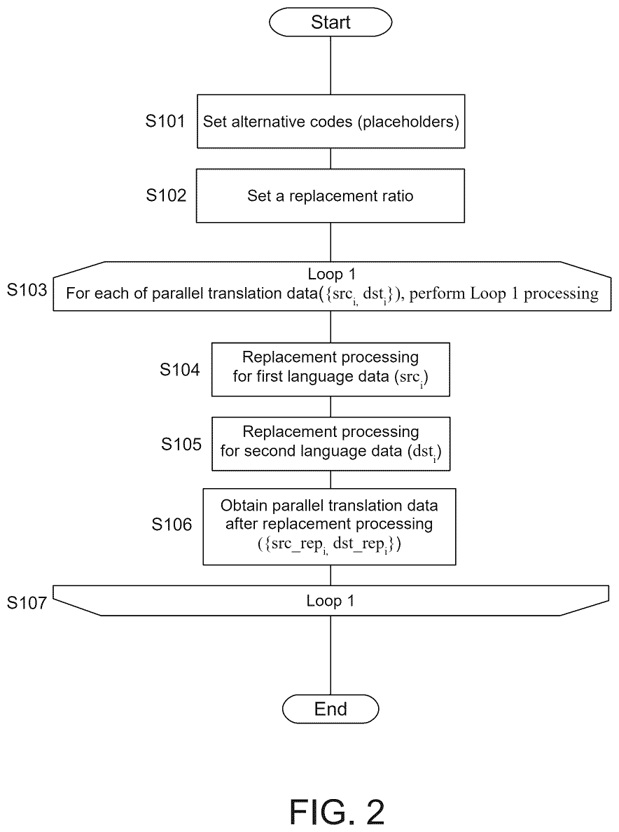

FIG. 2 is a flowchart of training data generation processing performed by the machine translation processing system 1000.

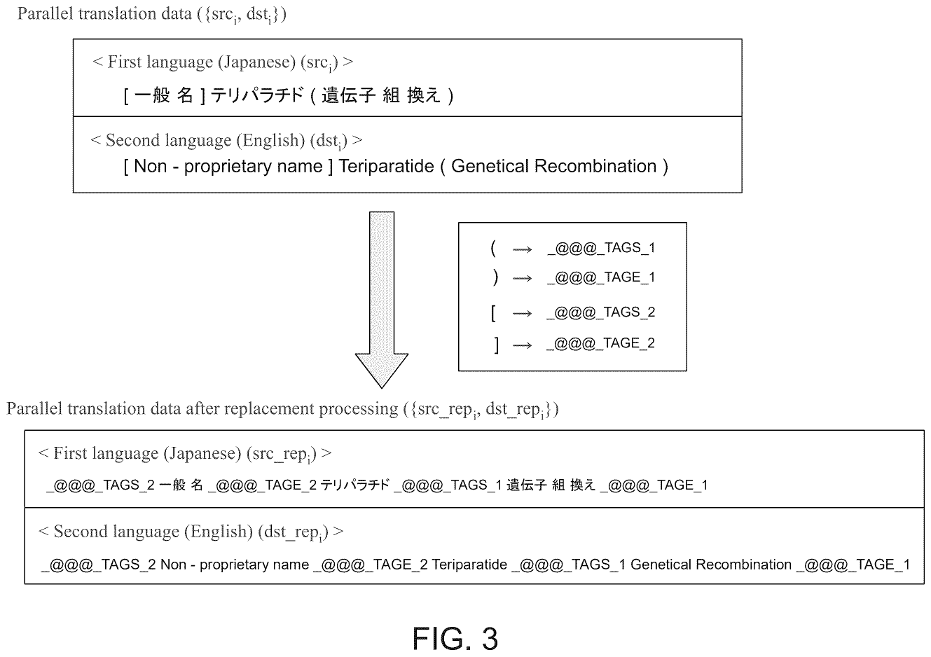

FIG. 3 is a diagram for explaining the replacement processing performed by the training data generation device 1 of the machine translation processing system 1000.

The training data generation processing performed by the machine translation processing system 1000 will be described below with reference to the flowchart in FIG. 2.

### Step S101:

In step S101, alternative codes (placeholders) setting processing is performed. Specifically, the processing is performed as follows.

The replacement processing unit 12 of the training data generation device 1 sets start/end correspondence codes to be replaced with alternative codes (placeholders) for the parallel translation data Din_tr (parallel translation data inputted into the training data generation device 1), which is a pair of the first language data (source language data) and the second language data (translation target language data) obtained by translating the first language data into the second language data, the parallel translation data Din_tr not including markup language tags.

The “start/end correspondence code” refers to a code that pairs a code indicating the start (or starting point) of a sequence of words or a sequence of characters (including a sequence of subwords) and a code indicating the end (or ending point) of a sequence of words or a sequence of characters (including a sequence of subwords), which is used in correspondence with the start code (used to form a pair). Examples of “start/end correspondence codes” include the following codes.
(1) ( ) (left round blacket (start code) and right parenthesis (end code))
(2) [ ] (left square bracket (start code) and right square bracket (end code))
(3) “ ” (left double quotation mark (start code) and right double quotation mark (end code))
(4) “(left single quotation mark (start code) and right single quotation mark (start code))

Note that the start/end correspondence codes should not be limited to the above, and may be any other code as long as the start code and end code correspond (the code on the left corresponds to the code on the right).

In addition, if the first or second language uses a 2-byte code character code, the start/end correspondence code in that language may be set as a 2-byte code (character code). For example, when the first language is Japanese, the second language is English, and furthermore the start/end correspondence codes are set to “( )” (left round bracket (start code) and right round bracket (end code)), (A) in Japanese (first language), which is a language that uses 2-byte codes, the start/end correspondence codes may be set as the left round bracket (start code) and right round bracket (end code) for 1-byte codes (half-width characters) and/or the left round bracket (start code) and right round bracket (end code) for 2-byte codes (full-width characters), and (B) in the second land (English), the start/end correspondence codes may be set as the left round bracket (start code) and right round bracket (end code) for 1-byte codes (half-width characters).

In the following, for convenience of explanation, a case will be described in which the first language is set to Japanese, the second language is set to English, and the start/end correspondence codes are set as follows:
(1) “( )” (left round bracket (start code) and right round bracket (end code))
(2) “[ ]” (left square bracket (start code) and right square bracket (end code))
   and for both the first and second languages, the start/end correspondence codes are set with 1-byte code characters (half-width characters).

The replacement processing unit 12 of the training data generation device 1 sets the first language to Japanese, the second language to English, and sets the start/end correspondence codes as follows:
(1) “( )” (left round bracket (start code) and right round bracket (end code)),
(2) “[ ]” (left square bracket (start code) and right square bracket (end code)).

### Step S102:

In step S102, replacement ratio setting processing is performed. Specifically, the processing is performed as follows.

The replacement ratio setting unit 11 sets the ratio of replacing start/end correspondence codes with alternative codes (placeholders). The replacement ratio setting unit 11 then transmits the set replacement ratio data (data indicating the ratio of replacing the start/end correspondence codes with the alternative codes (placeholders)) to the replacement processing unit 12 as data r_rep. In the present embodiment, for convenience of explanation, the following description will be made assuming that the replacement ratio setting unit 11 sets the ratio of replacing the start/end correspondence codes with the alternative codes (placeholders) to “0.1” (10%).

Note that it is preferable that the ratio set by the replacement ratio setting unit 11 (the ratio indicated by the replacement ratio data r_rep) is set so that the probability of the appearance of alternative codes (placeholders) therein is approximately the same as the probability of the appearance of markup language tags in the first language data including markup language tags (source language data) inputted into the machine translation processing device 2. In other words, it is preferable to make the appearance probability (appearance probability distribution) of alternative codes (placeholders) in the parallel translation data Do_tr after the above replacement processing close to the appearance probability (appearance probability distribution) of markup language tags in the first language data including markup language tags (source language data) (data subject to machine translation processing) inputted into the machine translation processing device 2. This causes the appearance probability distribution of alternative codes (placeholders) in the training data to be close to the appearance probability distribution of markup language tags in the language data that is actually subject to machine translation processing, thereby allowing for enhancing the accuracy of learning processing of machine translation processing using the above-described training data. Note that according to research by the inventor, the appearance probability of “( )” and “[ ]” in a large-scale corpus is about 0.1, and if 10% of them are replaced, 1% will be set as alternative codes. This ratio is close to the probability of appearance of markup language tags in the language data (including plain text and sentences with markup language tags) that is inputted for the target machine translation processing.

Furthermore, setting the replacement ratio by the replacement ratio setting unit 11 (by setting it to a value less than 1.0) guarantees that all start/end correspondence codes will not be replaced with alternative codes (placeholders). As a result, it is guaranteed that the parallel translation data after the replacement processing includes the start/end correspondence codes, thereby making it possible to appropriately learn (train) for the start/end correspondence codes (making it possible to make the start/end correspondence codes in the source language data correctly appear (correctly machine translated) in the machine translation processing result data (translation target language data)).

### Step S103:

In step S103, loop processing (loop 1) is started. When the parallel translation data Din_tr inputted into the training data generation device 1 is N sets (N is a natural number), for each parallel translation data {src_repᵢ, dst_repᵢ} (i is a natural number satisfying 1≤i≤N), the loop processing (loop 1) is performed N times. In other words, the loop processing (loop 1) is performed for the first parallel translation data {src_rep₁, dst_rep₁} through the N-th parallel translation data {src_rep_{N}, dst_rep_{N}}.

### Steps S104, S105:

In steps S104 and S105, replacement processing for the first language data (srcᵢ) and replacement processing for the second language data (dstᵢ) are performed. Specifically, the following processing is performed.

The replacement processing unit 12 receives the parallel translation data Din_tr that is parallel translation data that pairs data in the first language (source language data) with data in the second language (translation target language data), which is data obtained by translating data in the first language into data in the second language, and that does not include markup language tags. Note that the parallel translation data Din_tr is assumed to be data (a sequence of words, a sequence of subwords or the like) that has been subjected to morpheme analysis processing and separated into morphemes for both the first and second languages.

Further, the replacement processing unit 12 performs processing of replacing the start/end correspondence codes included in the parallel translation data Din_tr with alternative codes (placeholders) at the ratio indicated by the replacement ratio data r_rep transmitted from the replacement ratio setting unit 11. In the present embodiment, since the ratio indicated by the replacement ratio data r_rep is set to “0.1” (10%), the replacement processing unit 12 targets 10% of the sentences (parallel translation data) containing the start/end correspondence codes that are set to be replaced with alternative codes (placeholders) for the replacement processing (processing of replacing the start/end correspondence codes with the alternative codes (placeholders)), and then performs the replacement processing on the parallel translation data targeted for the replacement processing.

Here, a case of FIG. 3 will be described as an example of the replacement processing.

As shown in FIG. 3, it is assumed that the first language (Japanese) data (srcᵢ) and the second language (English) data (dstᵢ) of the i-th parallel translation data are as follows.

### <First Language (Japanese) Data (Srcᵢ)>

[ [symbol] ] [symbol] [symbol] [symbol] )

### <Second Language (English) Data (Dstᵢ)>

### [Non-Proprietary Name] Teriparatide (Genetical Recombination)

The replacement processing unit 12 has set the start/end correspondence codes to
(1) “( )” (left round bracket (start code) and right round bracket (end code))
(2) “[ ]” (left square bracket (start code) and right square bracket (end code)).

Thus, the replacement processing unit 12 replaces the above codes in (1) and (2) with the alternative codes (placeholders).

Specifically, the replacement processing unit 12 replaces the start code of the start/end correspondence codes with “TAGS_k” (or a string containing “TAGS_k”), and replace the end code of the start/end correspondence codes with “TAGE_k” (or a string containing “TAGE_k”) in the first language (Japanese) data (srcᵢ) and the second language (English) data (dstᵢ). Note that the subscript k of the alternative code for the start code and the alternative code for the end code is set to the same integer value for the same type of start and end correspondence codes within the same sentence (within the same parallel translation data); the subscript k is set to an integer value randomly obtained from a predetermined range.

In the case of the parallel translation data ({srcᵢ, dstᵢ}) shown in FIG. 3, the replacement processing unit 12 sets the alternative code for the left round bracket “(”, which is the start code of the start/end correspondence code “( )”, to “_@@@_TAGS_1”, and sets the alternative code for the right round bracket “)”, which is the end code of the start/end correspondence code “( )”, to “_@@@_TAGE_1”.

In addition, in the case of the parallel translation data ({srcᵢ, dstᵢ}) in FIG. 3, the replacement processing unit 12 sets the alternative code for the left square bracket “[”, which is the start code of the start/end correspondence code “[ ]”, to “_@@@_TAGS_2”, and sets the alternative code for the right square bracket “]”, which is the end code of the start/end correspondence code “[ ]”, to “_@@@_TAGE_2” (settings of replacement targets and alternative codes).

The replacement processing unit 12 then performs replacement processing on the first language (Japanese) data (srcᵢ) in accordance with the above-described settings of the replacement targets and alternative codes to obtain first language data src_repᵢ after the replacement processing. In other words, the replacement processing unit 12 obtains the following data as the first language data src_repᵢ after the replacement processing (step S104).

<First Language (Japanese) Data (Srcᵢ) after Replacement Processing>
_@@@_TAGS_2- [symbol] _@@@_TAGE_2 [symbol] _@@@_TAGS_1 [symbol] [symbol] _@@@_TAGE_1.

In addition, the replacement processing unit 12 performs replacement processing on the second language (English) data (dstᵢ) in accordance with the above-described settings of the replacement targets and alternative codes to obtain second language data dst_repᵢ after the replacement processing. In other words, the replacement processing unit 12 obtains the following data as the second language data dst_repᵢ after the replacement processing (step S105).

<Second Language (English) Data (Dstᵢ) after Replacement Processing>
_@@@_TAGS_2 Non-proprietary name _@@@_TAGE_2 Teriparatide_@@@_TAGS_1 Genetical Recombination _@@@_TAGE_1

### Step S106:

In step S106, the replacement processing unit 12 obtains parallel translation data ({src_repᵢ, dst_repᵢ}) after replacement processing in which the first language data src_repᵢ after replacement processing obtained in step S104 is paired with the second language data dst_repᵢ after replacement processing obtained in step S105 and then transmits the obtained parallel translation data ({src_repᵢ, dst_repᵢ}) after replacement processing to the data storage unit DB1 as the parallel translation data Do_tr after replacement processing and stores the data in the data storage unit DB1.

### Step S107:

In step S107, the replacement processing unit 12 determines whether the termination condition for the loop process (loop 1) is satisfied (whether the replacement processing has been performed on all the parallel translation data targeted for the replacement processing); when it is determined that the loop processing termination condition is not satisfied, the process returns to step S103 and the processes of steps S104 to S106 are performed. Conversely, when the replacement processing unit 12 determines that the loop processing termination condition is satisfied, the replacement processing unit 12 terminates the processing (terminates the training data generation processing).

As described above, in the training data generation device 1, for example, if the number of pieces of parallel translation data to be subjected to the replacement processing is N, the N pieces of parallel translation data after replacement processing are obtained (the ratio of the parallel translation data on which the replacement processing has been performed is 10% (the ratio set in r_rep) of the parallel translation sentences including the start/end correspondence codes that has been set as replacement targets).

The above processing allows the training data generation device 1 to insert alternative codes (placeholders) corresponding to markup language tags (e.g., XML tags) into parallel translation sentences (parallel translation data) that do not include markup language tags (e.g., XML tags). That is, the training data generation device 1 can obtain parallel translation sentences (parallel translation data) equivalent to parallel translation sentences (parallel translation data) with markup language tags (e.g., XML tags) through the above processing. In other words, the parallel translation data obtained by the training data generation device 1 in the above processing includes alternative codes (placeholders) corresponding to the markup language tags; thus, using the parallel translation data obtained through the above processing as training data for learning processing of the machine translation model achieves the same advantageous effect as when the machine translation model learning processing is performed using the parallel translation sentences (parallel translation data) with markup language tags (e.g., XML tags) as training data (equivalent learning processing can be performed).

### 1.2.2: Machine Translation Model Learning Processing (Training Processing) (Creation Method))

Next, the machine translation model learning processing (training processing) (creation method) performed by the machine translation processing system 1000 will be described.

The training data obtaining unit 21 transmits a data read command to the data storage unit DB1 to read out, from the data storage unit DB1, parallel translation data after replacement processing stored in the data storage unit DB1 as training parallel translation data Din_tr_rep (={src_repⱼ, dst_repⱼ}). The training data obtaining unit 21 extracts first language data (translation source language data) (src_repⱼ) from the training parallel translation data Din_tr_rep, and transmits the extracted first language data (translation source language data) to the first selector SEL21 as training input data Din_tr (=src_repⱼ). In addition, the training data obtaining unit 21 extracts second language data (translation target language data) (dst_repⱼ) that is paired with the first language data transmitted to the first selector SEL21 from the training parallel translation data Din_tr_rep and then transmits the extracted second language data (translation target language data) to the loss evaluation unit 24 as training correct data D_correct (=dst_repⱼ).

For convenience of explanation, it is assumed that the training data obtaining unit 21 reads out M sets (M is a natural number satisfying M≤N) of parallel translation data Din_tr after replacement processing from the data storage unit DB1, j-th first language data of the read-out parallel translation data Din_tr (j is a natural number satisfying 1≤j≤M) is denoted as “src_repⱼ”, second language data that is paired with the first language data (constituting parallel translation data) is denoted as “dst_repⱼ”, and j-th data (parallel translation data) of the parallel translation data Din_tr is denoted as “{src_repⱼ, dst_repⱼ}”.

The control unit (not shown) that controls each functional unit in the machine translation processing device 2 transmits a selection signal sel21 whose signal value is “O” to the first selector SEL21. The first selector SEL21 selects the data Din_tr in accordance with the selection signal, and then transmits the selected data Din_tr (=src_repⱼ) to the machine translation processing unit 23 as the data D1.

The machine translation model of the machine translation processing unit 23 receives the data D1 (=Din_tr) from the first selector SEL21, performs machine translation processing using the machine translation model, and then transmits the data obtained by the machine translation processing to to the second selector SEL22 as data D2.

The control unit (not shown) that controls each functional unit in the machine translation processing device 2 transmits a selection signal sel22 whose signal value is “0” to the second selector SEL22. The second selector SEL22 selects a path for outputting the data D2 transmitted from the machine translation processing unit 23 to the loss evaluation unit 24 in accordance with the selection signal, and then transmits the data D2 to the loss evaluation unit 24.

The loss evaluation unit 24 receives the training correct data D_correct transmitted from the training data obtaining unit 21 and the data D21 transmitted from the second selector SEL22. The loss evaluation unit 24 evaluates the loss (e.g., error) between the data D21 and the training correct data D_correct using, for example, a loss function and based on the evaluation result, generates parameter update data update(θ), which is data for updating parameters of the machine translation model of the machine translation processing unit 23. The loss evaluation unit 24 then transmits the generated parameter update data update(θ) to the machine translation processing unit 23. Note that in FIG. 1, the path from the output of the machine translation processing unit 23 to the loss evaluation unit 24 and the path for outputting parameter update data update(θ) from the loss evaluation unit 24 to the machine translation processing unit 23 are illustrated as separate paths, but this is for convenience (for convenience of illustration) and should not be limited to the form shown in FIG. 1. When the parameters of the machine translation model of the machine translation processing unit 23 is updated in the machine translation processing device 2 using the backpropagation method, an error obtained by the loss evaluation unit 24 (error obtained by an error function (e.g., cross-entropy error)) is propagated sequentially (back-propagated) along a path that reverses the path (forward propagation path) along which output data was obtained by the machine translation model in the machine translation processing unit 23, thereby updating each parameter of the machine translation model of the machine translation processing unit 23 (thereby updating parameters of each layer of the machine translation model of the machine translation processing unit 23).

In the machine translation processing device 2, the above learning processing is repeatedly performed on the parallel translation data ({src_repⱼ, dst_repⱼ}) obtained (read-out) from the data storage unit DB1 by the training data obtaining unit 21.

(1) When the error (loss) obtained by the loss evaluation unit 24 falls within a predetermined range, or (2) the amount of change in the error (loss) obtained by the loss evaluation unit 24 falls within a predetermined range, the value the loss evaluation unit 24 determines that there is no need to continue the learning processing and terminates the learning processing. The parameters set in the machine translation model of the machine translation processing unit 23 when the learning processing has been terminated are set (fixed) as optimization parameters for the machine translation model of the machine translation processing unit 23, and a trained model of the machine translation model of the machine translation processing unit 23 is obtained.

As described above, the machine translation processing system 1000 performs the machine translation model learning processing (training processing), thereby obtaining the trained model of the machine translation model of the machine translation processing unit 23.

### 1.2.3: Prediction Processing (Machine Translation Execution Processing)

Next, prediction processing (machine translation execution processing) performed by the machine translation processing system 1000 will be described.

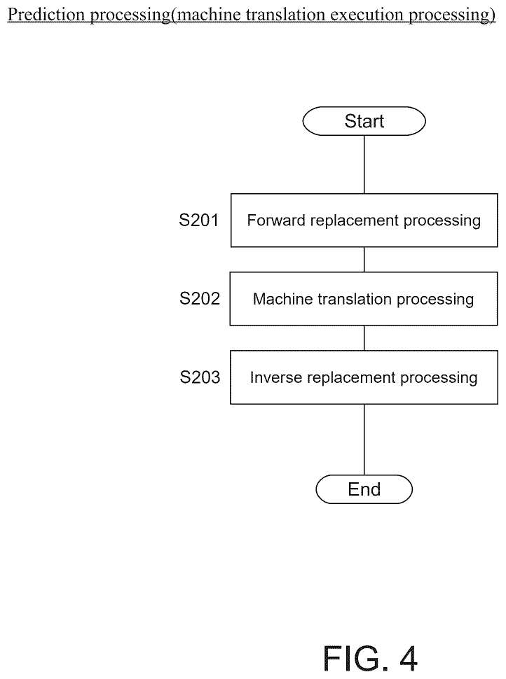

FIG. 4 is a flowchart of prediction processing (machine translation execution processing) performed by the machine translation processing system 1000.

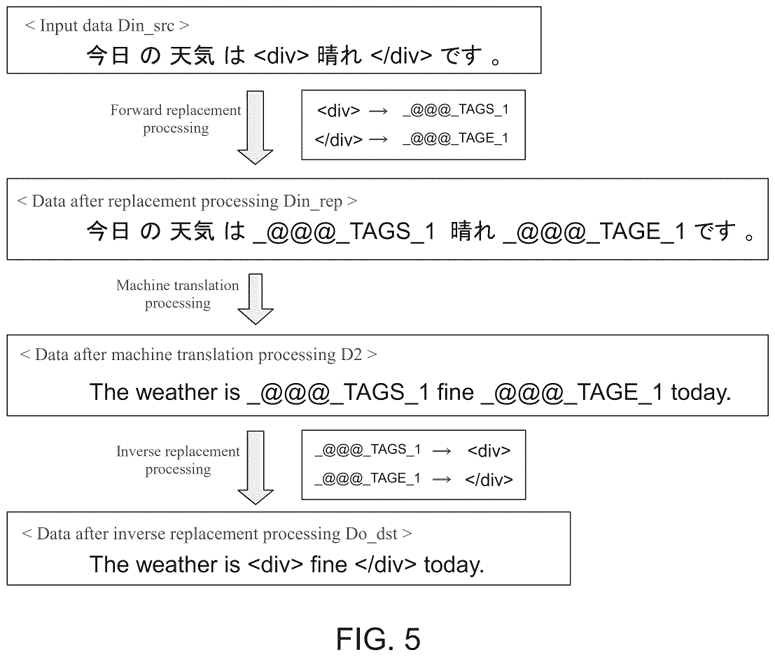

FIG. 5 is a diagram for explaining prediction processing (machine translation execution processing) of the machine translation processing system 1000.

The prediction processing (machine translation execution processing) performed by the machine translation processing system 1000 will now be described with reference to the flowchart in FIG. 4.

It is assumed that data in the first language (Japanese) including markup language tags (e.g., XML tags) is inputted into the machine translation processing device 2. Further, a case where the markup language tags are XML tags will be described below.

### Step S201:

In step S201, forward replacement processing is performed. Specifically, the following processing is performed.

The forward replacement processing unit 22 receives first language (Japanese) data, which is to be subjected to machine translation processing (source language data) and includes markup language tags (XML tags), as data Din_src. Note that the first language data (translation source language data) is assumed to be data (a sequence of words, a sequence of subwords or the like) that has been subjected to morphological analysis processing and separated into morphemes.

The forward replacement processing unit 22 detects markup language tags (XML tags) included in the data Din_src, and performs processing (forward replacement processing) of replacing the detected markup language tags (XML tags) with alternative codes (placeholders). The forward replacement processing unit 22 then transmits the first language data after the replacement processing to the first selector SEL21 as data Din_rep.

Note that the forward replacement processing unit 22 performs the forward replacement processing by replacing the XML start and end tags in the data (sentences) of the first language data Din_src, which contains the inputted tags for markup language (XML tags), with the same alternative codes (placeholders) as those that have been used during the training data generation processing. In other words, the forward replacement processing unit 22 (1) replaces the XML start tag in the data (sentence) of the first language data Din_src including the inputted markup language tags (XML tags) with “TAGS_k” (or a character string containing “TAGS_k”), and (2) replaces the XML end tag in the data (sentence) of the data Din_src with “TAGE_k” (or a character string containing “TAGE_k”).

Similarly to the training data generation processing, the subscript k of the alternative code for the XML start tag (“TAGS_k”) and the alternative code for the XML end tag (“TAGE_k”) is set to the same integer value for the same type of XML start and end tags within the same sentence (within the same input data (within the processing unit data subject to the forward replacement processing)); the subscript k is set to an integer value randomly obtained from a predetermined range.

For example, when the input data Din_src (= [symbol] [symbol] <div> [symbol] </div> [symbol] ) shown in FIG. 5 is inputted into the machine translation processing device 2, the forward replacement processing unit 22 detects the XML start tag “<div>” and end tag “</div>” included in the input data Din_src, performs forward replacement processing by replacing the XML start tag “<div>” with “_@@@_TAGS_1” and replacing the XML end tag “</div>” with “_@@@_TAGE_1”, thereby obtaining the data Din_rep after forward replacement processing (=┌ [symbol] [symbol] _@@@_TAGS 1 [symbol] _@@@_TAGE_1 [symbol] ).

The forward replacement processing unit 22 transmits the first language data after performing the above forward replacement processing to the first selector SEL21 as data Din_rep.

In addition, the forward replacement processing unit 22 generates a list of correspondences between XML tags and alternative codes (placeholders), which have replaced the XML tags in the forward replacement processing, and then transmits the data including the list to the inverse replacement processing unit 25 as data D_list_rep. In the case of FIG. 5, the forward replacement processing unit 22 generates a list indicating that the XML tag “<div>” has been replaced with the alternative code “_@@@_TAGS_1” and the XML tag “</div>” has been replaced with the alternative code “_@@@_TAGE_1”, and transmits data including the list to the inverse replacement processing unit 25 as data D_list_rep.

The control unit (not shown) that controls each functional unit in the machine translation processing device 2 transmits a selection signal sel21 whose signal value is “0” to the first selector SEL21. The first selector SEL21 selects the data Din_rep transmitted from the forward replacement processing unit 22 in accordance with the selection signal, and then transmits the selected data Din_rep to the machine translation processing unit 23 as data D1.

### Step S202:

In step S202, machine translation processing is performed. Specifically, the following processing is performed.

The machine translation model of the machine translation processing unit 23 receives data D1 (=Din_tr) from the first selector SEL21 and performs machine translation processing using the machine translation model.

For example, in the case of FIG. 5 in which the data Din_rep (= [symbol] [symbol] _@@@_TAGS_1 [symbol] _@@@_TAGE_ [symbol] after forward replacement processing is inputted into the machine translation model of the machine translation processing unit 23, the machine translation processing unit 23 performs machine translation processing on the input data using the machine translation model (trained model) to obtain result data (=“The weather is _@@@_TAGS_1 fine @@@_TAGE_1 today.”) shown in FIG. 5. The machine translation model of the machine translation processing unit 23 is a model optimized through the learning processing using parallel translation data including alternative codes (placeholders); thus, when data (first language data) in which XML tags have been replaced with the alternative codes (placeholders) is inputted into the machine translation model (trained model), the machine translation model (trained model) outputs (obtains) appropriately machine-translated sentences (machine translation processing result data (second language (English) data)) while retaining the alternative codes (placeholders) at the appropriate positions (positions in the sentence).

The data (data after machine translation processing) obtained by the machine translation model (trained model) of the machine translation processing unit 23 as described above is transmitted from the machine translation processing unit 23 to the second selector SEL22 as data D2.

The control unit (not shown) that controls each functional unit in the machine translation processing device 2 transmits a selection signal sel22 whose signal value is “1” to the second selector SEL22. The second selector SEL22 selects a path for outputting the data D2 transmitted from the machine translation processing unit 23 to the inverse replacement processing unit 25 in accordance with the selection signal, and then transmits the data D2 to the inverse replacement processing unit 25.

### Step S203:

In step S203, inverse replacement processing is performed. Specifically, the following processing is performed.

The inverse replacement processing unit 25 receives the data D22 transmitted from the second selector SEL22 and the data D_list_rep transmitted from the forward replacement processing unit 22. The inverse replacement processing unit 25 detects the alternative codes (placeholders) replaced by the forward replacement processing unit 22 from the data D22, and performs processing (inverse replacement processing) for returning (replacing) the detected alternative codes to (with) the original markup language tags based on the list contained in the data D_list_rep (a list of correspondences between markup language tags and the alternative codes (placeholders) that have replaced the markup language tags in the forward replacement processing).

For example, in the case of FIG. 5, the list indicating that the XML tag “<div>” has been replaced with the alternative code “@@@_TAGS_1”, and the XML tag “</div>” has been replaced with the alternative code “_@@@_TAGE_1” is included in the data D_list_rep; thus the inverse replacement processing unit 25 obtains the list and performs processing (inverse replacement processing) of replacing (returning) the alternative codes included in the data D2 after machine translation processing with (to) the original XML tags. In other words, in the case of FIG. 5, processing (inverse replacement processing) in which the alternative code “_@@@_TAGS_1” is replaced with (returned to) the XML tag “<div>” and the alternative code “_@@@_TAGE_1” is replaced with (returned to) the XML tag “</div>” (inverse replacement processing) in the data D2 after machine translation processing (= “The weather is @@@_TAGS_1 fine_@@@_TAGE_1 today.”) is performed. This causes the inverse replacement processing unit 25 to obtain the data after the inverse replacement processing (= “The weather is <div> fine </div> today.”).

The inverse replacement processing unit 25 outputs the data after performing the inverse replacement processing on the data D22 as output data Do_dst (= “The weather is <div> fine </div> today.” (in the case of FIG. 5)).

As described above, for input data containing XML tags, the machine translation processing system 1000 replaces the XML tags with alternative codes (placeholders) similar to those used when generating training data and then performs machine translation processing with the trained model of the machine translation model that has been optimized with the parallel translation data in which the alternative codes have been, thus allowing for obtaining appropriate machine translation processing result data while appropriately maintaining a state in which the alternative codes have been inserted. The machine translation processing system 1000 replaces the alternative codes with the XML tags in the machine translation processing result data (machine-translated sentences) in which the alternative codes have been inserted, thereby allowing for obtaining machine translation processing result data in which the XML tags have been appropriately inserted.

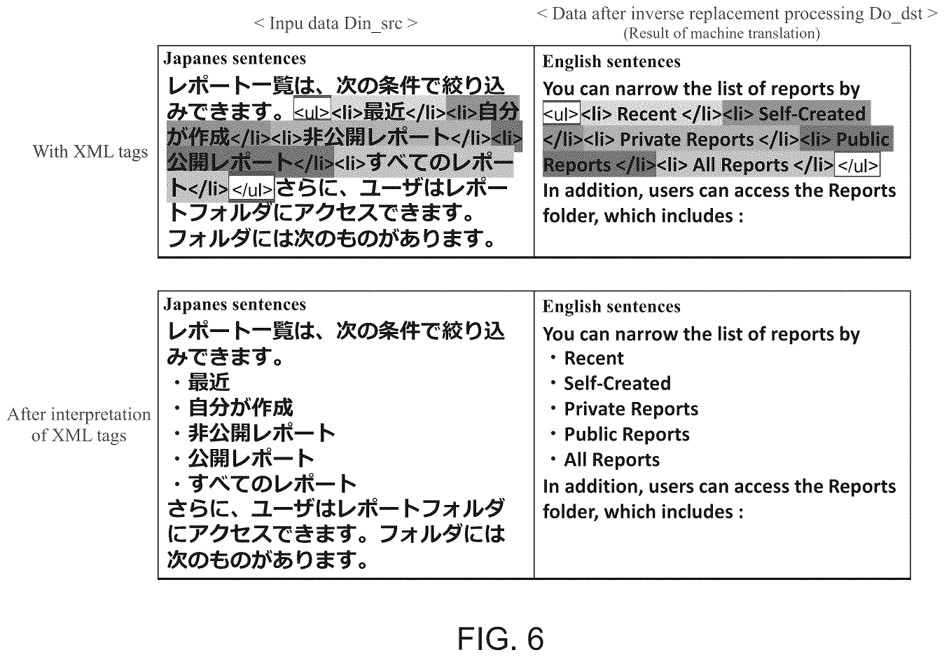

Note that FIG. 6 shows the result obtained by performing machine translation processing on first language data (Japanese data) including XML tags by the machine translation processing system 1000. The upper portion of FIG. 6 shows data with XML tags (XML source code) for the input data Din_src and the data Do_dst after the inverse replacement processing; the lower portion of FIG. 6 shows a display state when the XML tags of the input data Din_src and the data Do_dst after the inverse replacement processing are interpreted and displayed. As can be seen from FIG. 6, machine translation processing (machine translation processing from the first language (Japanese) to the second language (English)) is appropriately performed while maintaining the XML tags at appropriate positions.

### Summary of the Embodiment

As described above, in the machine translation processing system 1000, the training data generation device 1 performs training data generation processing to detect the start/end correspondence codes (codes whose left and right sides correspond, such as ( ) and [ ]) and replace the detected start/end correspondence codes with alternative codes (placeholders) in parallel translation sentences (parallel translation data) that do not include markup language tags (e.g., XML tags), thereby allowing for easily generating a large amount of data equivalent to parallel translation data into which markup language tags (e.g., XML tags) have been inserted.

The parallel translation data obtained in the training data generation processing by the training data generation device 1 of machine translation processing system 1000 includes alternative codes (placeholders) corresponding to the markup language tags; thus, using the parallel translation data obtained through the training data generation processing by the training data generation device 1 as training data for learning processing of the machine translation model achieves the same advantageous effect as when the machine translation model learning processing is performed using the parallel translation sentences (parallel translation data) with markup language tags (e.g., XML tags) as training data (equivalent learning processing can be performed).

In addition, for input data including markup language tags (e.g., XML tags), the machine translation processing system 1000 replaces the markup language tags with alternative codes (places) similar to those used when generating training data, and then performs using the trained machine translation model that has been optimized using the parallel translation data in which the alternative codes have been inserted, thus allowing for obtaining appropriate machine translation processing result data while appropriately maintaining a state in which the alternative codes have been inserted. The machine translation processing system 1000 replaces (returns) the alternative codes with (to) the XML tags in the machine translation processing result data (machine-translated sentences) in which the alternative codes have been inserted, thereby allowing for obtaining machine translation processing result data in which the XML tags have been inserted.

This allows the machine translation processing system 1000 to perform high accurate machine translation on original text data (source language data (source language sentences)) to be translated in which markup language tags have been included while retaining the information about the markup language tags without having to prepare a large amount of parallel translation data including tags.

### Second Embodiment

Next, a second embodiment will be described. Note that the same parts as in the above embodiment are denoted by the same reference numerals, and detailed description thereof will be omitted.

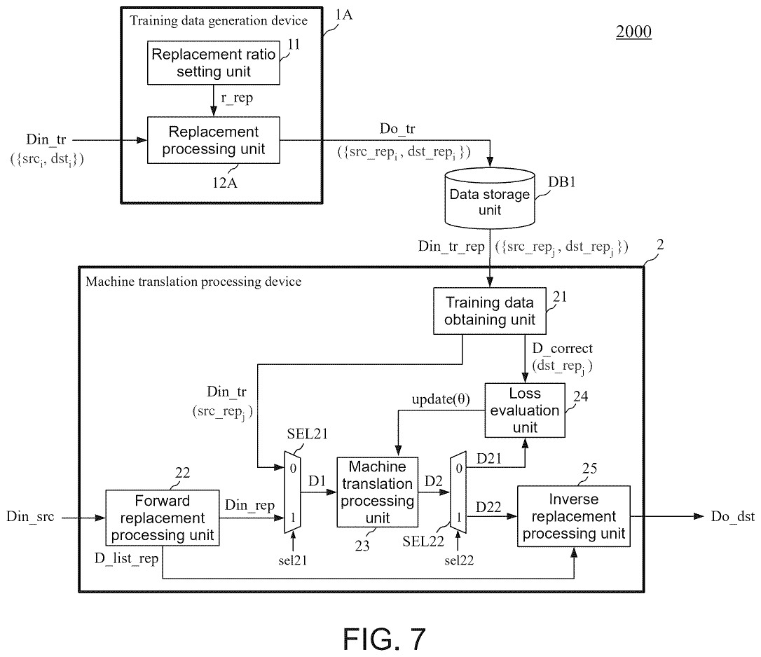

FIG. 7 is a schematic configuration diagram of a machine translation processing system 2000 according to the second embodiment.

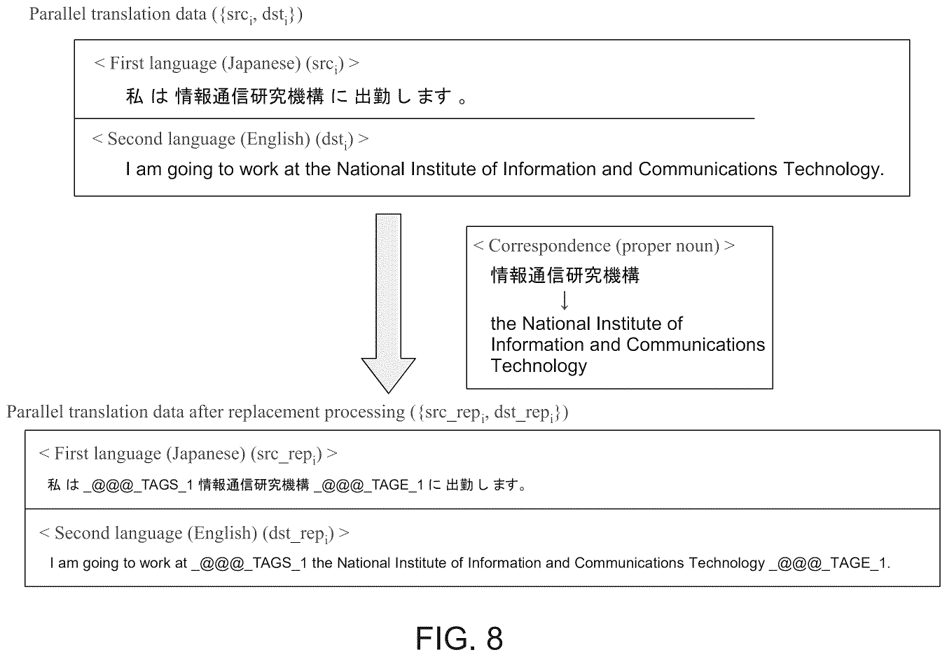

FIG. 8 is a diagram for explaining the replacement processing performed by the training data generation device 1A of the machine translation processing system 2000.

The machine translation processing system 2000 of the second embodiment has a configuration in which the training data generation device 1 is replaced with a training data generation device 1A in the machine translation processing system 1000 of the first embodiment.

The training data generation device 1A has a configuration in which the replacement processing unit 12 in the training data generation device 1 of the first embodiment is replaced with a replacement processing unit 12A. Other than those described above, the machine translation processing system 2000 of the second embodiment is the same as the machine translation processing system 1000 of the first embodiment.

The replacement processing unit 12A receives parallel translation data Din_tr in which first language data (source language data) is paired with second language data (translation target language data) and furthermore markup language tags are not included. The replacement processing unit 12A inserts alternative codes (placeholders) around corresponding elements in the parallel translation data Din_tr (in parallel translation sentences). For example, when there is a clear correspondence between the first language data (original sentence) and the second language data (translated sentence) such as proper nouns and numbers or when word alignment processing is performed, thereby clarifying correspondence between words or phrases, the replacement processing unit 12A performs processing of inserting alternative codes (placeholders) before and after the element for which the correspondence has been established. The replacement processing unit 12A uses the same codes as in the first embodiment as alternative codes (placeholders).

Specifically, the replacement processing unit 12A (1) inserts an alternative code “TAGS_k” (or a character string containing “TAGS_k”), which is the start code described in the first embodiment, before an element (word, subword, or the like) whose correspondence between in the first language (original sentences) and in the second language (translated sentences) has been established and (2) inserts an alternative code “TAGE_k” (or a character string containing “TAGE_k”), which is the end code described in the first embodiment, after the element (word, subword, or the like) whose correspondence between in the first language (original sentences) and in the second language (translated sentences) has been established.

Here, the case of FIG. 8 will be described as an example of the replacement processing by the replacement processing unit 12A.

As shown in FIG. 8, it is assumed that the first language (Japanese) data (srcᵢ) and the second language (English) data (dstᵢ) of the i-th parallel translation data are as follows.

### <First Language (Japanese) Data (Srcᵢ)>

[symbol]

[symbol]

[symbol]

[symbol]

[symbol]

### <Second Language (English) Data (Dstᵢ)>

I am going to work at the National Institute of Information and Communications Technology.

The replacement processing unit 12A detects corresponding element(s) (proper nouns in the above example) between the first language data and the second language data, and then inserts alternative codes (placeholders) before and after the detected element(s). In other words, the replacement processing unit 12A detects the proper noun “ [symbol] [symbol] ” in the first language data and “the National Institute of Information and Communications Technology” corresponding to the proper noun of the first language in the second language (detects the corresponding proper noun), and then inserts alternative codes (placeholders) before and after the detected element (in the above example, the character string that constitutes the proper noun). This causes the replacement processing unit 12A to obtain the following parallel translation data ({src_repᵢ, dst_repᵢ}) after replacement processing, as shown in FIG. 8.

<First Language (Japanese) Data (Srcᵢ) after Replacement Processing> [symbol]
_@@@_TAGS_1 [symbol] [symbol] _@@@_TAGE_1 [symbol] [symbol]
<Second Language (English) Data (Dstᵢ) after Replacement Processing>
I am going to work at _@@@_TAGS_1 the National Institute of Information and Communications Technology _@@@_TAGE_1.

Note that, similarly to the first embodiment, the replacement processing unit 12A performs the above-described replacement processing (inserting alternative codes (placeholders) to replace the corresponding element(s) with them) at the ratio set by the replacement ratio setting unit 11 (the ratio indicated by the replacement ratio data r_rep).

Note that it is preferable that the ratio set by the replacement ratio setting unit 11 (the ratio indicated by the replacement ratio data r_rep, the ratio of a case in the second embodiment is 1%) is set so that the probability of the appearance of alternative codes (placeholders) therein is approximately the same as the probability of the appearance of markup language tags in the first language data including markup language tags (source language data) inputted into the machine translation processing device 2. In other words, it is preferable to make the appearance probability (appearance probability distribution) of alternative codes (placeholders) in the parallel translation data Do_tr after the above replacement processing close to the appearance probability (appearance probability distribution) of markup language tags in the first language data (source language data) (data subject to machine translation processing) inputted into the machine translation processing device 2. This causes the appearance probability distribution of alternative codes (placeholders) in the training data to be close to the appearance probability distribution of markup language tags in the language data, with markup language tags, that is actually subject to machine translation processing, thereby allowing for enhancing the accuracy of learning processing of machine translation processing using the above-described training data.

The data Do_tr obtained by the training data generation device 1A through the above processing is stored in the data storage unit DB1, and is used for processing of learning (training) a machine translation model in the machine translation processing system 2000, similarly to the first embodiment. Prediction processing (machine translation execution processing) is then performed in the machine translation processing system 2000 in which the learning processing has been completed.

As described above, in the machine translation processing system 2000, training data generation device 1A performs training data generation processing to detect element(s) for which correspondence between original sentences and its translated sentences has been established in parallel translation sentences (parallel translation data) that do not include markup language tags (e.g., XML tags), and then insert alternative codes (placeholders) before and after the detected element(s), thereby allowing for easily generating a large amount of data equivalent to parallel translation data into which markup language tags (e.g., XML tags) have been inserted.

The parallel translation data obtained in the training data generation processing by the training data generation device 1A of the machine translation processing system 2000 includes alternative codes (placeholders) corresponding to the markup language tags; thus, using the parallel translation data obtained through the training data generation processing by the training data generation device 1A as training data for learning processing of the machine translation model achieves the same advantageous effect as when the machine translation model learning processing is performed using the parallel translation sentences (parallel translation data) with markup language tags (e.g., XML tags) as training data (equivalent learning processing can be performed).

In addition, for input data including markup language tags (e.g., XML tags), the machine translation processing system 2000 replaces the markup language tags with alternative codes (places) similar to those used when generating training data, and then performs using the trained machine translation model that has been optimized using the parallel translation data in which the alternative codes have been inserted, thus allowing for obtaining appropriate machine translation processing result data while appropriately maintaining a state in which the alternative codes have been inserted. The machine translation processing system 2000 replaces (returns) the alternative codes with (to) the XML tags in the machine translation processing result data (machine-translated sentences) in which the alternative codes have been inserted, thereby allowing for obtaining machine translation processing result data in which the XML tags have been appropriately inserted.

This allows the machine translation processing system 2000 to perform high accurate machine translation on original text data (source language data (source language sentences)) to be translated in which markup language tags have been included while retaining the information about the markup language tags without having to prepare a large amount of parallel translation data including tags.

### OTHER EMBODIMENTS

Each functional unit of the machine translation processing systems 1000 and 2000 described in the above embodiments may be achieved with one device (system), or may be achieved with a plurality of devices.

Further, some or all of the above embodiments may be combined.

Further, in the above embodiments, a case has been described in which parallel translation data that has been subjected to morphological analysis processing or first language data is inputted into the training data generation devices 1 and 1A and the machine translation processing device 2; however, the present invention should not be limited to this; parallel translation data that has not been subjected to morphological analysis processing or first language data may be inputted into the training data generation devices 1 and 1A and the machine translation processing device 2. In this case, the morphological analysis unit may be provided at a position preceding the replacement processing units 12 and 12A and the forward replacement processing unit 22. Parallel translation data or data of a language (first language data) to be machine translated for data sequence (a sequence of words, a sequence of subwords) that has been separated into morphemes by a morphological analysis unit may be inputted into the training data generation device 1 and 1A, or the machine translation processing device 2.

Furthermore, in the above embodiments, a case has been described in which the first language data is Japanese and the second language data is English; however, the present invention should not be limited to this, and the first language data and/or the second language data may be data of other languages. In other words, in the machine translation processing systems 1000 and 2000 of the above embodiments, the translation source language and translation target language may be any language.

In addition, if there is a commonly used start/end correspondence code in the first language data and second language data, the machine translation processing system 1000, 2000 may perform replacement processing of replacing the commonly used start/end correspondence code with an alternative code (placeholder).

Each block of the machine translation processing system 1000, 2000 described in the above embodiments may be formed using a single chip with a semiconductor device, such as LSI, or some or all of the blocks of the machine translation processing system 1000, 2000 may be formed using a single chip.

Note that although the term LSI is used here, it may also be called IC, system LSI, super LSI, or ultra LSI depending on the degree of integration.

Further, the method of circuit integration should not be limited to LSI, and it may be implemented with a dedicated circuit or a general-purpose processor. A field programmable gate array (FPGA) that can be programmed after the LSI is manufactured, or a reconfigurable processor that can reconfigure connection and setting of circuit cells inside the LSI may be used.

Further, a part or all of the processing of each functional block of each of the above embodiments may be implemented with a program. A part or all of the processing of each functional block of each of the above-described embodiments is then performed by a central processing unit (CPU) in a computer. The programs for these processes may be stored in a storage device, such as a hard disk or a ROM, and may be executed from the ROM or be read into a RAM and then executed.

The processes described in the above embodiments may be implemented by using either hardware or software (including use of an operating system (OS), middleware, or a predetermined library), or may be implemented using both software and hardware.

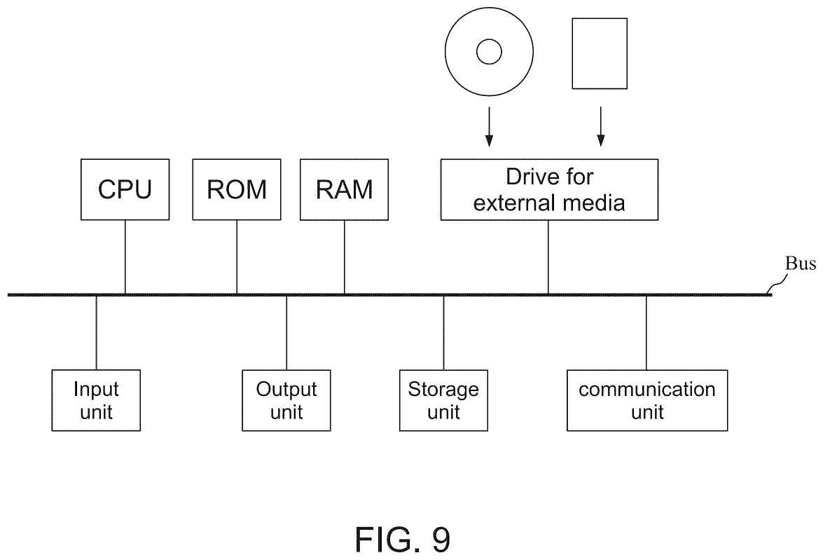

For example, when each functional unit of the above embodiments is achieved by using software, the hardware structure (the hardware structure including CPU(s), GPU(s), ROM, RAM, an input unit, an output unit, a communication unit, a storage unit (e.g., a storage unit achieved by using HDD, SSD, or the like), a drive for external media or the like, each of which is connected to a bus) shown in FIG. 9 may be employed to achieve the functional units by using software.

When each functional unit of the above embodiments is achieved by using software, the software may be achieved by using a single computer having the hardware configuration shown in FIG. 9, and may be achieved by using distributed processes using a plurality of computers.

The processes described in the above embodiments may not be performed in the order specified in the above embodiments. The order in which the processes are performed may be changed without departing from the scope and the spirit of the invention. Further, in the processing method in the above-described embodiments, some steps may be performed in parallel with other steps without departing from the scope and the spirit of the invention.

The present invention may also include a computer program enabling a computer to implement the method described in the above embodiments and a computer readable recording medium on which such a program is recorded. Examples of the computer readable recording medium include a flexible disk, a hard disk, a CD-ROM, an MO, a DVD, a DVD-ROM, a DVD-RAM, a large capacity DVD, a next-generation DVD, and a semiconductor memory.

The computer program should not be limited to one recorded on the recording medium, but may be transmitted via an electric communication line, a wireless or wired communication line, a network represented by the Internet, or the like.

The specific structures described in the above embodiments are mere examples of the present invention, and may be changed and modified variously without departing from the scope and the spirit of the invention.

### REFERENCE SIGNS LIST

1000, 2000 machine translation processing system
1, 1A training data generation device
11 replacement ratio setting unit 11
12, 12A replacement processing unit
2 machine translation processing device
22 forward replacement processing unit
23 machine translation processing unit
24 loss evaluation unit
25 inverse replacement processing unit

What is claimed is:

1. A method for generating training data for machine translation, which is for generating training data for training a learnable model for machine translation processing in a machine translation processing system for machine translation processing of language data including markup language tags, the method comprising:
a start/end correspondence code detection step of detecting a start/end correspondence code, whose correspondence between a start indication code and an end indication code has been established, in parallel translation data in which first language data is paired with second language data obtained by translating the first language data into second language data, the parallel translation data not including the markup language tags; and
a replacement processing step of performing replacement processing in which the start/end correspondence code is replaced with an alternative code for the parallel translation data to obtain parallel translation data after the replacement processing.

2. The method for generating training data for machine translation according to claim 1, further comprising a replacement ratio setting step of setting a replacement ratio, wherein
the replacement processing step includes performing replacement processing on the parallel translation data to replace the start/end correspondence code with an alternative code at the replacement ratio set in the replacement ratio setting step.

3. A method for creating a learnable model for machine translation processing in a machine translation processing system for performing machine translation processing on language data including markup language tags using training data generated by the method for generating training data for machine translation according to claim 1 or 2, the method comprising:
a data input step of inputting the first language data included in the parallel translation data after the replacement processing into the learnable model for the machine translation processing;
an output data obtaining step of obtaining output data of the learnable model for machine translation processing for the data inputted in the data input step;
a loss evaluation step of obtaining the output data obtained in the output data obtaining step and the second language data included in the parallel translation data after the replacement processing as correct data, and evaluating a loss between the output data and the correct data; and
a parameter updating step of updating parameters of the learnable model for machine translation processing so that the loss obtained in the loss evaluation step is reduced.

4. A machine translation processing method for performing machine translation processing using a learned model obtained by training a learnable model for machine translation processing by the method for creating a learnable model for machine translation processing according to claim 3, the method comprising:
a forward replacement processing step of performing forward replacement processing of replacing the markup language tag included in the input first language data with the alternative code;
a machine translation processing step of performing machine translation processing on first language data after the forward replacement processing using the learned model of the learnable model for machine translation processing to obtain second language data after machine translation processing; and
an inverse replacement processing step of performing inverse replacement processing of replacing the alternative code included in the second language data after the machine translation processing obtained in the machine translation processing step with the markup language tag that has been replaced in the forward replacement processing step.

5. A method for generating training data for machine translation, which is for generating training data for training a learnable model for machine translation processing in a machine translation processing system for machine translation processing of language data including markup language tags, the method comprising:
a corresponding element detection step of detecting a corresponding element that is determined to be element whose correspondence between first language data and second language has been established for the parallel translation data that is obtained by pairing the first language data with the second language data, which is obtained by translating the first language data into second language data, the parallel translation data not including the markup language tags; and
a replacement processing step of performing replacement processing on the parallel translation data to insert alternative codes before and after the corresponding element, thereby obtaining parallel translation data after the replacement processing.

6. A device for generating training data for machine translation, which is for generating training data for training a learnable model for machine translation processing in a machine translation processing system for performing machine translation processing on language data including markup language tags, the device comprising:
a replacement processing unit that detects a start/end correspondence code, whose correspondence between a start indication code and an end indication code has been established, in parallel translation data in which first language data is paired with second language data obtained by translating the first language data into second language data, the parallel translation data not including the markup language tags, and that performs replacement processing in which the start/end correspondence code is replaced with an alternative code for the parallel translation data to obtain parallel translation data after the replacement processing.
